(19) United States
(12) Patent Application Publication
(10) Pub. No.: US 2023/0028182 A1
(43) Pub. Date: Jan. 26, 2023

(54) APPARATUSES, SYSTEMS, AND METHOD FOR FILTRATION

(71) Applicant: Lehigh University, Bethlehem, PA (US)

(72) Inventors: Arup K. SenGupta, Bethlehem, PA (US); Hao Chen, Bethlehem, PA (US)

(21) Appl. No.: 17/867,750

(22) Filed: Jul. 19, 2022

Related U.S. Application Data
(60) Provisional application No. 63/305,900, filed on Feb. 2, 2022.
(60) Provisional application No. 63/223,163, filed on Jul. 19, 2021.

(51) Int. Cl. C02F 1/42; C02F 1/04; B01D 1/14; B01D 5/00; B01J 47/014; B01J 47/06; B01J 43/00

(52) U.S. Cl. CPC C02F 1/42; C02F 1/043; B01D 1/14; B01D 5/006; B01J 47/014; B01J 47/06; B01J 43/00; C02F 2103/08

(57) ABSTRACT

Methods, systems, and apparatuses for recovering water from an aqueous stream containing a solute are disclosed herein. In accordance with an aspect, provided is method comprising receiving an inlet brine stream comprising water and a solute; producing a concentrated brine stream by contacting the inlet brine stream with an ion exchange resin configured to extract water from the inlet brine stream, the ion exchange resin comprising a plurality of pores adapted to receive water molecules; ceasing the contact of the ion exchange resin with the inlet brine stream and the concentrated brine stream; and evaporating at least a portion of the water contained in the ion exchange resin aided by unsaturated air with less than 100% relative humidity using an evaporation unit.

### CROSS-REFERENCE TO RELATED APPLICATION

This application claims the benefit of priority from U.S. Provisional Patent Application No. 63/305,900, filed Feb. 2, 2022, and U.S. Provisional Patent Application No. 63/223,163, filed Jul. 19, 2021, the contents of which are hereby incorporated herein by reference in their entireties.

### FIELD OF THE DISCLOSURE

The present disclosure relates to apparatuses, systems, and methods for recovering water from an aqueous stream, such as a brine stream.

### BACKGROUND

Water is very important for human life, and for modern industrial manufacturing and chemical production. Water supplies which feed industrial plants for the production of potable water for distribution and/or consumption, often contain unacceptably high levels of dissolved solutes. Recent desalination techniques for purifying contaminated water, brine produced by interatrial process, and/or seawater have been studied in various ways.

Conventional desalination technology removes various suspended substances or ionic components contained in contaminated water, such as seawater and wastewater, by using an evaporation method that evaporates moisture using a heat source, such as fossil fuel or electricity, and a separation membrane. Filtration removes foreign substances and electrodialysis removes ions using the electrolysis of electrode cells. When the total dissolved solids (“TDS”) of brine solution and/or stream exceeds 50,000 mg/L (Sea water's TDS is approximately 35,000 mg/L), reverse osmosis (“RO”) is not suitable due to very high osmotic pressure of the saline water.

Accordingly, there is an ongoing need for systems, methods, and apparatuses for recovering water from an aqueous solutions, such as a brine stream.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description and brief description of the drawings provided below.

Aspects of the invention are generally directed to methods, systems, and apparatuses for recovering water from an aqueous stream containing a solute. Aspects of the invention are generally directed to methods, systems, and apparatuses for recovering water from an aqueous stream containing a solute. For instance, the systems and methods disclosed herein may advantageously be used for recovering water from streams/solutions having high concentrations of solutes, such as brines, hypersalinated water, wastewater from oil and/or natural gas drill sites. Certain embodiments of the apparatus and methods disclosed herein advantageously combine the efficient extraction of water using particular ion exchange resins disclosed herein with cost-effective evaporation and condensation to recover at least a portion of water extracted by the ion exchange resins. For instance, in some embodiments, ambient air or a gas having a temperature and relative humidity similar to surrounding ambient air may be used for evaporating the water from the ion exchange particles.

In accordance with an aspect of the invention, provided is method comprising receiving an inlet brine stream comprising water and a solute; producing a concentrated brine stream by contacting the inlet brine stream with an ion exchange resin configured to extract water from the inlet brine stream, the ion exchange resin comprising a plurality of pores adapted to receive water molecules; ceasing the contact of the ion exchange resin with the inlet brine stream and the concentrated brine stream; and evaporating at least a portion of the water contained in the ion exchange resin using an evaporation unit.

According to another aspect of the invention, a system is provided for recovering water from an aqueous stream. The system typically comprises a filtration housing comprising having an feed solution inlet configured to receive a feed stream, one or more ion exchange resin doped with at least one metal oxide, and a concentrated solution outlet configured to receive a concentrated stream; and an evaporation unit configured to blow air in contact with the one or more ion exchange resin. The one or more ion exchange resin typically comprise a surface layer, an inner layer, and a plurality of pores adapted to receive water molecules, wherein at least one of the plurality of pores extends from the surface layer to the inner layer.

In accordance with a further aspect of the invention, provided is a method for recovering water from an aqueous stream. The method typically comprises receiving an inlet aqueous stream comprising water and having a solute concentration level of about 1,000 mg/L to about 300,000 mg/L; producing a concentrated aqueous stream by contacting the inlet aqueous stream with an ion exchange resin configured to extract water from the inlet aqueous stream, the ion exchange resin comprising a plurality of pores adapted to receive water molecules; ceasing the contact of the ion exchange resin with the inlet aqueous stream and the concentrated inlet aqueous stream; and evaporating at least a portion of the water contained in the ion exchange resin using an evaporation unit.

### BRIEF DESCRIPTION OF THE DRAWINGS

The present invention will become more fully understood from the detailed description and the accompanying drawings, wherein like elements are labeled similarly and in which:

FIG. 1 is a schematic of a system for recovering water from an aqueous stream according to aspects of the invention;

FIG. 2 is a flow chart of a method for recovering water from an aqueous stream in accordance with aspects of the invention;

FIG. 3A is a schematic of extraction of water from an aqueous feed stream using ion exchange resins and recovery of water by evaporation and condensation according to aspects of the invention;

FIG. 3B is a schematic of a system in accordance with an aspect of the invention;

FIG. 4 is a graph illustrating the maximum water capacity of non-limiting, exemplary ion exchange resins according to aspects of the invention;

FIG. 5 shows the water uptake for an exemplary embodiment of an anionic ion exchange resin at different relative humidity and at two different temperatures, namely 30° C. and 50° C., in accordance with aspects of the invention;

FIG. 6 is a bar graph illustrating the concentration of total dissolved solute in the outlet and in the feed solution according to aspects of the invention;

FIG. 7 is a bar graph illustrating the concentration of Na₂SO₄ and the concentration of NaCl in an outlet solution when passed through the air-dried cation ion exchange resin in accordance with aspects of the invention;

FIG. 8 is a bar graph showing the concentration of total dissolved solutes in an outlet solution in the absence of ion exchanging functional groups according to aspects of the invention;

FIG. 9A is an image of an exemplary system for removing water from a feed stream using ion exchange resins and subsequently recovering water from the ion exchange resins using evaporation in accordance with aspects of the invention;

FIG. 9B is a schematic of the exemplary system of FIG. 9A;

FIG. 10 is a bar graph showing the concentration of total dissolved solute in an outlet solution accordance with aspects of the invention;

FIG. 11 is a graph depicting the flow history curve of inlet and outlet temperatures of an exemplary evaporation unit according to aspects of the invention;

FIG. 12 is a graph depicting the flow history curve of the relative humidity of an inlet gas stream and an outlet gas stream for an exemplary evaporation unit according to aspects of the invention;

FIG. 13 is a graph showing the concentration of total dissolved solutes in the concentrated wastewater stream over three consecutive cycles of recovering water in accordance with aspects of the invention;

FIG. 14 is a graph showing temperatures curves of three consecutive evaporation cycles for wastewater according to aspects of the invention;

FIG. 15 is a graph showing relative humidity for three consecutive evaporation cycles for wastewater according to aspects of the invention;

FIG. 16 is a graph showing the total dissolved solute in an aqueous solution after removal of water over ten consecutive cycles of operation in accordance with aspects of the invention;

FIG. 17 is a non-limiting, exemplary system for removing water from a feed stream using ion exchange resins and subsequently recovering water from the ion exchange resins using evaporation according to another aspect of the invention; and

FIG. 18 shows the water recovered for each of the five cycles using the system shown in FIG. 17.

All drawings are not necessarily to scale. Components numbered and appearing in one figure but appearing un-numbered in other figures are the same unless expressly noted otherwise. A reference herein to a whole figure number which appears in multiple figures bearing the same whole number but with different alphabetical suffixes shall be constructed as a general refer to all of those figures unless expressly noted otherwise.

### DETAILED DESCRIPTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other compositions and methods. Before explaining the disclosed embodiments of the present invention in detail, it is to be understood that the invention is not limited in its application to the details of any particular embodiment shown or described. The terminology used herein is for the purpose of description and not of limitation.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

The abbreviations and symbols as used herein, unless indicated otherwise, take their ordinary meaning. The abbreviation “wt. %” means percent by weight with respect to the personal care composition. The symbol “°” refers to a degree, such as a temperature degree or a degree of an angle. The symbols “h”, “min”, “mL”, “nm”, “μm” each respectively refer to hour, minute, milliliter, nanometer, and micrometer.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but are not limited to”.

As used throughout, any ranges disclosed herein are used as shorthand for describing each and every value that is within the range. Any value within the range can be selected as the terminus of the range. The term “about” when referring to a number means any number within a range of 10% of the number. For example, the phrase “about 2.0 wt. %” refers to a number between and including 1.8 wt. % and 2.2 wt. %. The term “substantially” when referring to a geometric shape generally means that the shape may be within a 10% deviation of the geometric shape.

In addition, all references cited herein are hereby incorporated by referenced in their entireties. In the event of a conflict in a definition in the present disclosure and that of a cited reference, the present disclosure controls.

Aspects of the invention are generally directed to methods, systems, and apparatuses for recovering water from an aqueous stream containing a solute. As discussed above, the systems and methods disclosed herein may advantageously be used for recovering water from streams/solutions having high concentrations of solutes, such as brines, hypersalinated water, wastewater from oil and/or natural gas drill sites. Certain embodiments of the apparatus and methods disclosed herein advantageously combine the efficient extraction of water using particular ion exchange resins disclosed herein with cost-effective evaporation and condensation to recover at least a portion of water extracted by the ion exchange resins. In some embodiments, ambient air or a gas having a temperature and relative humidity similar to surrounding ambient air may be used for evaporating the water from the ion exchange particles.

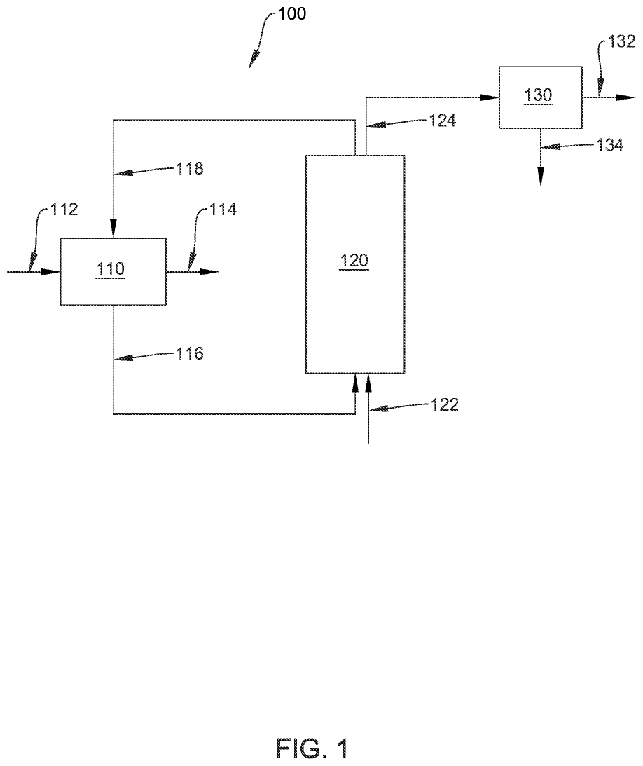

In accordance with an aspect of the invention, provided is an exemplary embodiment of a system 100 for recovering water from an aqueous solution and/or stream containing a solute. Referring to FIG. 1, system 100 includes a filtration housing 110 having a feed solution inlet, a concentrated solution outlet, and one or more ion exchange resin(s), System 100 also includes an evaporation unit 120 and may, preferably, include a condenser 130.

Filtration housing 110 is generally configured to house one or more ion exchange resin and enable contact of the ion exchange resin(s) with a feed solution. The ion exchange resins are typically adapted to extract water from an aqueous solution and/or an aqueous stream. For example, the ion exchange resin may extract water from the aqueous solution/stream via osmosis. The ion exchange resin may retain water when submerged in an aqueous solution/stream and/or in an environment having 100% or more relative humidity. Additionally or alternatively, the ion exchange resin may be adapted to release water when contacting a gas stream and/or in an environment having a relative humidity of less than 100%.

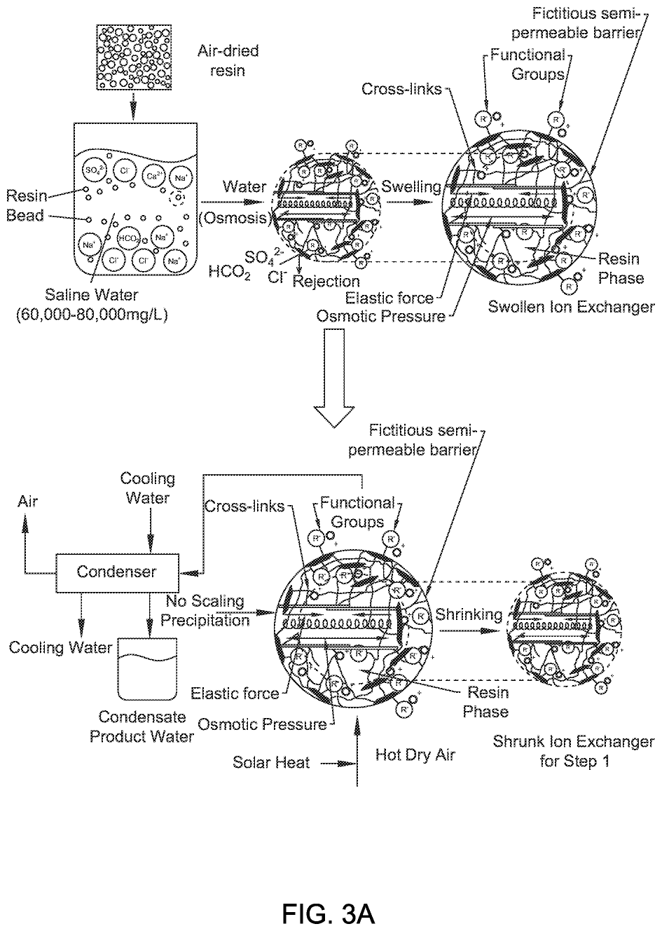

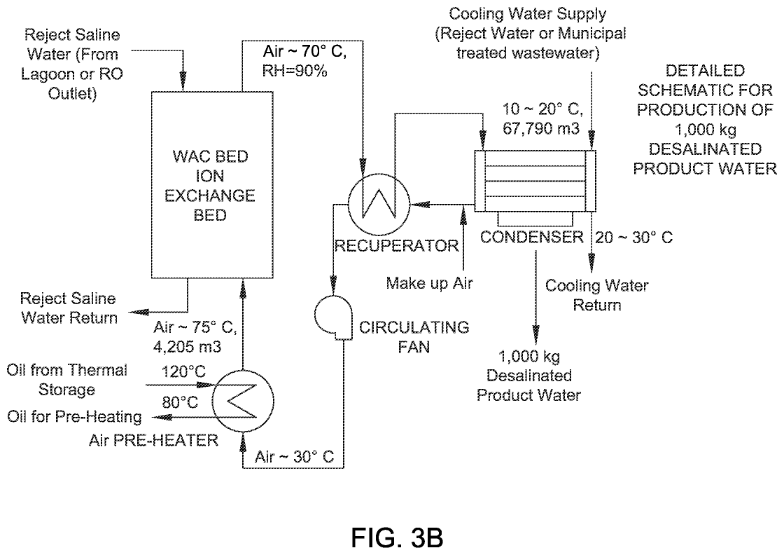

The ion exchange resin(s) typically comprise a surface layer, an inner layer, and a plurality of pores adapted to receive water molecules. The ion exchange resin may be in the form of a bead, cylinder, pellet, cube, rectangular cuboid, or the like. Although the ion exchange resin is illustrated in FIG. 3A as having a spherical or substantially spherical shape, the ion exchange resin may have a geometric shape or non-geometric shape. The ion exchange resin(s) may comprise or be formed a plurality of nanofibers comprising one or more polymers.

In at least one preferred embodiment, the ion exchange resin is in the form of a bead that may be substantially spherical or spherical. The ion exchange resin may be in a form or shape having a diameter that ranges from about 100 μm to about 10,000 μm. For example, the diameter may be from about 100 μm to about 10,000 μm, about 100 μm to about 8,000 μm, about 100 μm to about 6,000 μm, about 100 μm to about 4,000 μm, about 100 μm to about 2,000 μm, about 100 μm to about 1,000 μm, about 100 μm to about 800 μm; from about 300 μm to about 10,000 μm, about 300 μm to about 8,000 μm, about 300 μm to about 6,000 μm, about 300 μm to about 4,000 μm, about 300 μm to about 2,000 μm, about 300 μm to about 1,000 μm, about 300 μm to about 800 μm; from about 500 μm to about 10,000 μm, about 500 μm to about 8,000 μm, about 500 μm to about 6,000 μm, about 500 μm to about 4,000 μm, about 500 μm to about 2,000 μm, about 500 μm to about 1,000 μm, about 500 μm to about 800 μm; from about 700 μm to about 10,000 μm, about 700 μm to about 8,000 μm, about 700 μm to about 6,000 μm, about 700 μm to about 4,000 μm, about 700 μm to about 2,000 μm, about 700 μm to about 1,000 μm; from about 900 μm to about 10,000 μm, about 900 μm to about 8,000 μm, about 900 μm to about 6,000 μm, about 900 μm to about 4,000 μm, about 900 μm to about 2,000 μm; from about 1500 μm to about 10,000 μm, about 1500 μm to about 8,000 μm, about 1500 μm to about 6,000 μm, about 1500 μm to about 4,000 μm, or any range or subrange thereof. In some embodiments where the ion exchange resin is in a form or has a shape having at least two diameters, the range for the two diameters may be independently selected from any of foregoing ranges listed for the diameter.

The one or more ion exchange resin may be configured to retain water under a first condition and configured to release water under a second condition. For example, the one or more ion exchange resins may be configured to retain water in an environment having a relative humidity of 100% or more and configured to release water in an environment having a relative humidity of less than 100%, such as a relative humidity of about 90% or less, about 80% or less, about 70% or less, about 60% or less, about 50% or less, or about 40% or less of relative humidity.

The ion exchange resin(s) may be adapted to swell due to extraction of water. For instance, the ion exchange resin may be adapted extract/remove water when in contact with an aqueous solution and/or aqueous stream, and swell to a size that is about 150 to about 500% larger than the initial size of the ion exchange resin (e.g., when in a dry state). In some embodiments, the ion exchange resin is adapted to swell to a size that is larger than the initial size (i.e., before contact with the aqueous solution/stream) of ion exchange resin by about 150 to about 400%, about 150 to about 300%, about 150 to about 200%; about 200 to about 500%, about 200 to about 400%, about 200 to about 300%; from about 250 to about 500%, about 250 to about 400%, about 250 to about 300%, about 250 to about 200%; from about 300 to about 500%, about 300 to about 400%; from about 350 to about 500%, about 350 to about 400%, or any range or subrange thereof.

Preferably, at least one of the plurality of pores extends from surface layer of the ion exchange resin to an inner layer of the ion exchange resin. The average pore size for the plurality of pores may be about 1 nm (nanometer) to about 50 nms. For instance, the average pore size for the plurality of pores may be from about 1 to about 50 nms, about 1 to about 40 nms, about 1 to about 30 nms, about 1 to about 20 nms, about 1 to about 10 nms, about 1 to about 5 nms; from about 5 to about 50 nms, about 5 to about 40 nms, about 5 to about 30 nms, about 5 to about 20 nms, about 5 to about 10 nms; from about 10 to about 50 nms, about 10 to about 40 nms, about 10 to about 30 nms, about 10 to about 20 nms; from about 20 to about 50 nms, about 20 to about 40 nms, about 20 to about 30 nms; from about 30 to about 50 nms, about 30 to about 40 nms, about 40 to about 50 nms, or any range or subrange thereof.

The ion exchange resin may comprise one or more polymers. In some preferred embodiments, the ion exchange resin(s) comprises one or more polymers selected from polystyrene, polyacrylic acid, and mixtures of two or more thereof. In certain embodiments, the ion exchange resin consists of polystyrene, polyacrylic acid, or mixtures of two or more thereof. Non-limiting examples of polymers that may, additionally or alternatively, be present in the ion exchange resin include polybutylene, polyethylene, polyvinyl, and combinations thereof. The one or more polymers of the ion exchange resin may be cross-linked. The one or more polymers may be cross-linked with divinylbenzene or the like. Non-limiting examples of polymers that may, in some instances, be present in ion exchange resins include: polyolefins, such as polyethylenes and polypropylenes; fluorocarbon resins, such as polytetrafluoroethylenes (PTFEs), polychlorotrifluoroethylene (CTFE), tetrafluoroethylene-perfluoroalkyl vinyl ether copolymers (PFAs), and poly(vinylidene fluoride)s (PVDFs); halogenated polyolefins, such as poly(vinyl chloride)s; polyamides, such as nylon-6 and nylon-66; urea resins; phenolic resins; melamine resins; polystyrenes; cellulose; cellulose acetate; cellulose nitrate; poly(ether ketone)s; poly(ether ketone ketone)s; poly(ether ether ketone)s; polysulfones; poly(ether sulfone)s; polyimides; polyetherimides; polyamide-imides; polybenzoimidazoles; polycarbonates; poly(ethylene terephthalate)s, poly(butylene terephthalate)s; poly(phenylene sulfide)s; polyacrylonitriles; poly(ether nitrile)s; and copolymers of two or more thereof.

The one or more polymers include a plurality of functional groups. For example, the polymer(s) may have one or more functional groups, such that the ion exchange resin is an anionic ion exchange resin or a cationic ion exchange resin. In some instances, the ion exchange resin is a strong base anionic ion exchange resin, a weak base anionic ion exchange resin, strong acid cationic ion exchange resin, and/or weak acid cationic ion exchange resin. Suitable examples for the one or more functional groups of the one or more polymer(s) include a sulfonic acid, a quaternary ammonium, a primary amine, and combinations thereof. In some cases, the surface of the ion exchange resin is functionalized to have one or more functional groups, such as those selected from carboxylic acid, a sulfonic acid, a quaternary ammonium, a primary amine, and a combination of two or more thereof. Additionally or alternatively, the inner layer of the ion exchange resin may be functionalized to have one or more functional groups, such as those selected from carboxylic acid, a sulfonic acid, a quaternary ammonium, a primary amine, and a combination of two or more thereof.

In certain embodiments, the cationic exchange resin may be conditioned with hydrochloric acid or nitric acid to remove contained impurities to an absolute minimum and to increase the substitutional rate with hydrogen atoms. In further embodiments, the anion exchange resin may be conditioned typically with sodium hydroxide to remove contained impurities to an absolute minimum and to increase the substitutional rate with hydroxyl groups.

Preferably, the ion exchange resins comprises a doping agent. For example, the ion exchange resin may be doped with one or more metal oxides. Suitable metal oxides include, e.g., iron oxide, zirconium oxide, copper oxide, and a combinations thereof. The doping agent(s) may be present in the ion exchange resin(s) in an amount from about 0.5 to about 30 wt. %, based on the total dry weight of the ion exchange resin. For example, the ion exchange resin(s) may include the doping agent(s) in an amount from about 0.5 to about 30 wt. %, about 0.5 to about 25 wt. %, about 0.5 to about 20 wt. %, about 0.5 to about 15 wt. %, about 0.5 to about 10 wt. %, about 0.5 to about 5 wt. %, about 1 to about 2 wt. %; from about 1 to about 30 wt. %, about 1 to about 25 wt. %, about 1 to about 20 wt. %, about 1 to about 15 wt. %, about 1 to about 10 wt. %, about 1 to about 5 wt. %, about 1 to about 2 wt. %; from about 5 to about 30 wt. %, about 5 to about 25 wt. %, about 5 to about 20 wt. %, about 5 to about 15 wt. %, about 5 to about 10 wt. %; from about 7.5 to about 30 wt. %, about 7.5 to about 25 wt. %, about 7.5 to about 20 wt. %, about 7.5 to about 15 wt. %, about 7.5 to about 10 wt. %; from about 10 to about 30 wt. %, about 10 to about 25 wt. %, about 10 to about 20 wt. %, about 10 to about 15 wt. %; from about 15 to about 30 wt. %, about 15 to about 25 wt. %, about 15 to about 20 wt. %, including any range or subrange thereof, based on the total dry weight of the ion exchange resin.

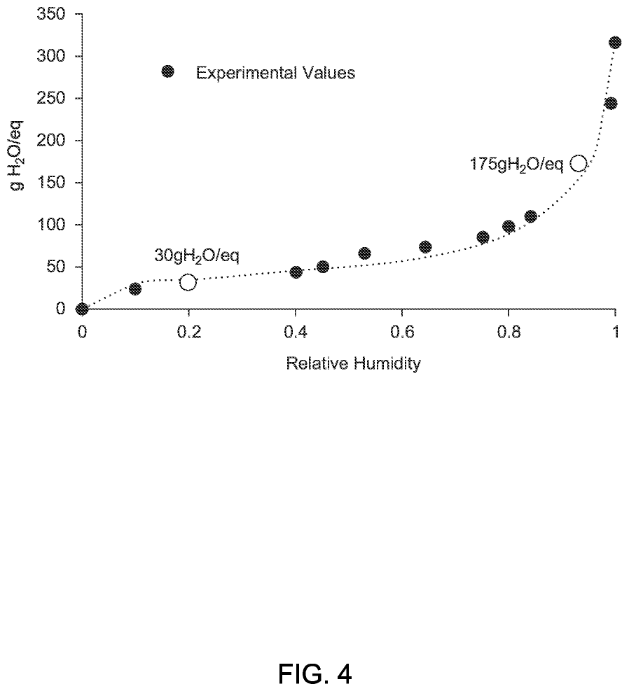

The ion exchange resin(s) may be adapted to have a maximum capacity for containing water (“maximum water capacity”) at 100% relative humidity ranging from about 1 gram of water per gram of ion exchange resin to about 3 grams of water per gram of ion exchange resin. For example, the ion exchange resin(s) may have a maximum water capacity at 100% relative humidity of about 1 to about 3, about 1.3 to about 3, about 1.6 to about 3, about 1.9 to about 3, about 2.1 to about 3, about 2.4 to about 3, about 2.7 to about 3; from about 1 to about 2.5, about 1.3 to about 2.5, about 1.6 to about 2.5, about 1.9 to about 2.5, about 2.1 to about 2.5, about 2.4 to about 2.5, about 2.7 to about 2.5; from about 1 to about 2, about 1.3 to about 2, about 1.6 to about 2; from about 1 to about 1.5, about 1.3 to about 1.5, or any range or subrange thereof, gram of water per gram of ion exchange resin. A graph of maximum water capacity of non-limiting, exemplary ion exchange resins according to an embodiment of the invention is shown in FIG. 4. The y-axis of FIG. 4 refers to the grams H₂O per one equivalent capacity of the ion exchange resin.

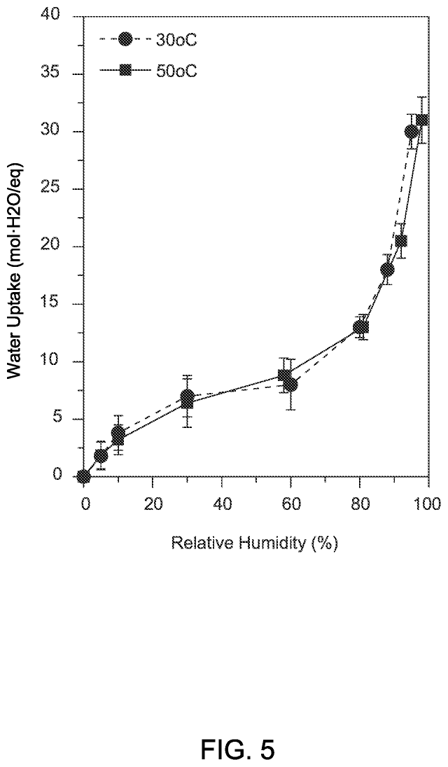

As seen in FIG. 5, embodiments of the ion exchange resin may exhibit an increase in water uptake at high relative humidity levels. Further, the water uptake curves may typically be about the same at various temperatures ranging from about 30° C. to about 50° C. In some embodiments, that the water content of the ion exchange resin is nearly five times less at 20% relative humidity than when it is saturated with water.

Preferably, the ion exchange resin may be adapted to have a maximum water capacity that decreases with the relative humidity of the surrounding environment (e.g., gas or air). For example, in some preferred embodiments, the ion exchange resin is adapted to have a maximum water capacity at a relative humidity of 80% that is about 50% or less of the maximum water content of the ion exchange resin at a relative humidity of 100%. In some instances, the ion exchange resin is adapted to have a maximum water capacity at a relative humidity of 80% that is about 50% or less, about 40% or less, about 35% or less, about 30% or less, or about 25% or less than the maximum water content of the ion exchange resin at a relative humidity of 100%. Additionally or alternatively, the ion exchange resin is adapted to have a maximum water capacity at a relative humidity of 20% that is about 30% or less, about 20% or less, about 15% or less, or about 10% or less than the maximum water content of the ion exchange resin at a relative humidity of 100%.

The ion exchange resin may be adapted to have a 6.3 milli-equivalents per gram of air-dried resin, i.e., the ion exchange resin is equivalent to an electrolyte concentration of 6.3 M. For instance, ion exchange resins having a ion charge capacity of 6.3 M have a ion charge capacity equivalent to 6.3 M of charged anions or cations in one liter, i.e., an electrolyte concentration of 6.3M. In some embodiments, the ion exchange resin has an ion charge capacity of about 2 to about 10, about 4 to about 10, about 6 to about 10, about 8 to about 10; about 2 to about 8, about 4 to about 8, about 6 to about 8; about 2 to about 6, about 4 to about 6, or about 2 to 4 milli-equivalents per gram of air-dried resin.

Filtration housing 110 is typically configured to contain one or more ion exchange resins. The ion exchange resins may be enveloped in layer, e.g., as part of filtration membrane. Examples of filtration membranes, filtration housings, and filter systems that may incorporated into the systems and methods disclosed herein can be found in U.S. Pat. Nos. 9,156,001 and 10,688,441, which are incorporated herein in their entirety for all purposes. Additionally or alternatively, the ion exchange resins may be contained or enveloped in a porous fabric, screen, net, or the like that facilitates removal of the ion exchange resins from the filtration housing 110.

Filtration housing 110 comprises a feed solution inlet that is configured to receive a feed solution stream 112. In some cases, the feed solution inlet may be fluidically coupled to a feed solution stream source. For example, the feed solution inlet may be in fluid communication with the feed solution source by way of fluidic coupling to a feed solution conduit. Suitable feed solution conduits includes pipes, hoses, and ducts comprised of materials that preferably do not chemically interact with the feed solution stream. The feed solution inlet of filtration housing 110 may receive feed solution stream 112 continuously or intermittently (e.g., in the form of batches of the feed solution stream).

Filtration housing 110 typically includes a concentrated solution outlet configured to receive a concentrated stream 114. The concentrated stream 114 may comprises the same solute as feed solution stream 112, but in higher concentrations to reflect the removal of water by the ion exchange resin(s). The concentrated solution outlet may be fluidically coupled to a concentrated solution conduit for transportation of concentrated solution stream 114 to a desired location. Suitable concentrated solution conduits includes pipes, hoses, and ducts comprised of materials that preferably do not chemically interact with the concentrated solution stream.

Filtration housing 110 may include an ion exchange resin inlet configured to receive and provide the one or more ion exchange resins to an inner chamber of filtration housing 110. Filtration housing 110 may include an ion exchange resin outlet that is configured to receive the one or more ion exchange resins. In some embodiments, however, the one or more ion exchanger resin may be provided to the inner chamber of the filtration housing and/or removed from the inner chamber of the filtration housing via a single aperture. Although the ion exchange resin outlet of filtration housing 110 is depicted in FIG. 1 as being coupled to evaporation unit 120 by ion exchange resin outlet stream, in some embodiments the ion exchange resin outlet of filtration housing 110 is not coupled or attached to evaporation unit 120. For instance, the ion exchange resins may be removed from filtration housing 110 after extracting/removing water from feed solution stream 112 and transported to evaporation unit 120, e.g., via manual labor, robotic labor, a convey belt, a conduit, a channel, or the like.

System 100 also includes an evaporation unit 120 that is configured to receive one or more ion exchange resins. Evaporation 120 is configured to dry and/or remove at least a portion of the water contained in the ion exchange resin(s). Suitable examples of evaporation unit 120 include rotary dryers, dryer columns, circular fluid bed dryers, compress air driers and/or the like. Evaporation unit 120 typically includes a gas stream inlet that is configured to receive an inlet gas stream 122 and a gas stream outlet configured to receive an outlet gas stream 124.

Inlet gas stream 122 may comprise or consist of air. In at least one embodiment, inlet gas stream 122 is ambient air. Inlet gas stream 122 preferably has a relative humidity of less than 100%. For example, the inlet gas stream 122 may have a relative humidity of about 90% or less, about 80% or less, about 70% or less, about 60% or less, about 50% or less, about 40% or less, about 30% or less, about 20% or less, about 10% or less, or about 5% or less.

Evaporation unit 120 may be configured to heat inlet gas stream 122. In some embodiments, however, evaporation unit 120 does not heat inlet gas stream 122. Inlet gas stream may have a temperature of about 10 to about 50° C. in evaporation unit 120. For example, the temperature of inlet gas stream entering evaporation unit 120 may be about 10 to about 50° C., about 10 to about 45° C., about 10 to about 40° C., about 10 to about 35° C., about 10 to about 30° C., about 10 to about 25° C., about 10 to about 20° C.; from about 15 to about 50° C., about 15 to about 45° C., about 15 to about 40° C., about 15 to about 35° C., about 15 to about 30° C., about 15 to about 25° C., about 15 to about 20° C.; from about 20 to about 50° C., about 20 to about 45° C., about 20 to about 40° C., about 20 to about 35° C., about 20 to about 30° C., about 20 to about 25° C.; from about 25 to about 50° C., about 25 to about 45° C., about 25 to about 40° C., about 25 to about 35° C., about 25 to about 30° C.; from about 30 to about 50° C., about 30 to about 45° C., about 30 to about 40° C., about 23 to about 35° C.; from about 35 to about 50° C., about 35 to about 45° C., about 35 to about 40° C., or any range or subrange thereof.

Evaporation unit 120 may be configured to facilitate contact between inlet gas stream 122 and one or more ion exchange resin(s). For example, evaporation unit 120 may have a blower and/or compressor to blow inlet gas stream 122 in contact with the ion exchange resin(s) to promote removal of a least a portion of the water contained in the ion exchange resin(s) via evaporation. As the ion exchange resin(s) contact the inlet gas stream 122, the ion exchange resins preferably release at least a portion of the water contained therein. In some embodiments, the ion exchange resin(s) release about 50% or more of the water contained therein. In certain embodiments, the ion exchange resin(s) release about 60% or more, about 70% or more, about 80% or more, about 85% or more, about 90% or more, about 95% or more, about 97% or more, or about 99% or more of the water contained in the ion exchange resins. In some preferred embodiments, the ion exchange resins are recycled to the filtration housing 110 after releasing a portion of the water previously contained therein. Although FIG. 1 depicts an ion exchange stream 118 as a recycle stream that provides ion exchange resin(s) that have released at least a portion of the water previously contained therein to filtration housing 110 from evaporation unit 120, in some embodiments ion exchange stream 118 is not fluicially attached or coupled to evaporation unit 120 or filtration housing 120. For instance, the ion exchange resins may be removed from evaporation unit 120 after releasing at least a portion of the water previously contained therein and transported to filtration housing 110, e.g., via manual labor, robotic labor, a convey belt, a conduit, a channel, or the like. The water recovered from the ion exchange resin(s) may be in the form of a vapor, which forms part of outlet gas stream 124.

Outlet gas stream 124 preferably has a relative humidity that is higher than that of inlet gas stream 122. Outlet gas stream 124 may have a relative humidity that is about 20% or more, about 30% or more, about 40% or more, about 60% or more, about 80% or more, about 100% or more, or about 200% or more higher than the relative humidity of inlet gas stream 122. Outlet gas stream 124 may be fluidically coupled to a condenser 130. For example, the gas stream outlet may be fluidically coupled to condenser 130 by way of an outlet gas stream, such that outlet gas stream 124 is in fluidic communication with condenser 130.

System 100 may include a condenser 130 that is configured to recover water from a gas stream containing water vapor via condensing the water vapor out of the gas stream. Condenser 130 may comprise a gas inlet configured to receive outlet gas stream 124. As shown in FIG. 1, condenser 130 may be configured to receive outlet gas stream 124 from evaporation unit 120 and produce a liquid stream 134 and a dry gas stream 132. Dry gas stream 134 typically contains less water vapor than outlet gas stream 124 from evaporation unit 120.

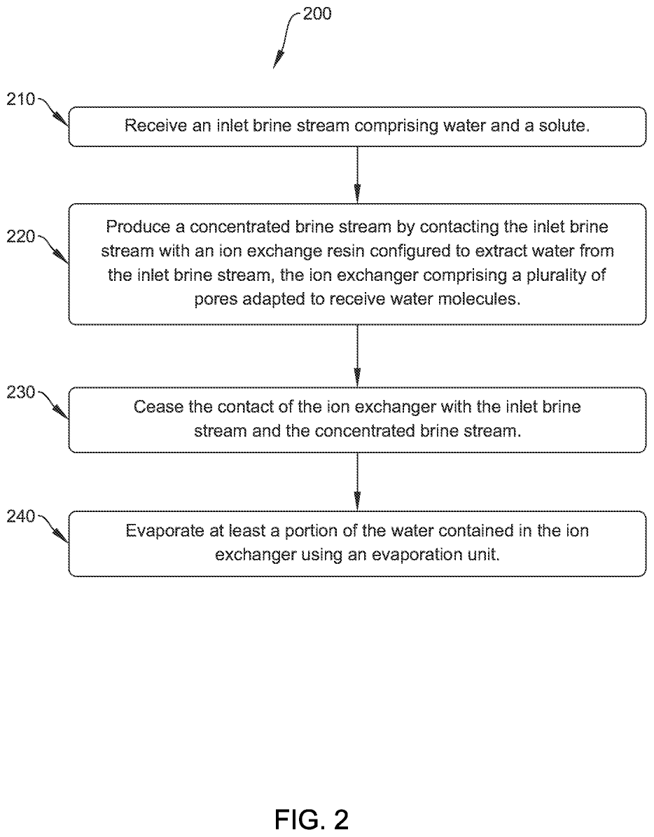

In accordance with another aspect, provided is a method 200 for recovering water from an aqueous solution/stream. Method 200 may employ any of the systems, apparatuses, and/or ion exchange resins disclosed herein and/or one or more components thereof. For example, method 200 may use system 100 and/or any components/features, which are described above. With reference to FIG. 2, method 200 generally includes receiving an inlet brine stream comprising water and a solute; produce a concentrated brine stream by contacting the inlet brine stream with an ion exchange resin configured to extract water from the inlet brine stream, the ion exchanger comprising a plurality of pores adapted to receive water molecules; ceasing the contact of the ion exchanger with the inlet brine stream and the concentrated brine stream; and evaporating at least a portion of the water contained in the ion exchanger using an evaporation unit.

In step 210, an inlet brine stream comprising water and a solute is received. For example, the inlet brine stream may be received by a filtration housing, such as filtration housing 210. The inlet brine stream may be similar or the same as feed stream 112. The brine stream may have a total amount of solutes in the range of about 1,000 mg/L to about 300,000 mg/L. For example, the total amount of solute present in the brine stream may be from about 1,000 to about 300,000 mg/L, about 1,000 to about 250,000 mg/L, about 1,000 to about 200,000 mg/L, about 1,000 to about 100,000 mg/L, about 1,000 to about 75,000 mg/L, about 1,000 to about 50,000 mg/L, about 1,000 to about 30,000 mg/L; from about 10,000 to about 300,000 mg/L, about 10,000 to about 250,000 mg/L, about 10,000 to about 200,000 mg/L, about 10,000 to about 100,000 mg/L, about 10,000 to about 75,000 mg/L, about 10,000 to about 50,000 mg/L, about 10,000 to about 30,000 mg/L; from about 30,000 to about 300,000 mg/L, about 30,000 to about 250,000 mg/L, about 30,000 to about 200,000 mg/L, about 30,000 to about 100,000 mg/L, about 30,000 to about 75,000 mg/L, about 30,000 to about 50,000 mg/L; from about 90,000 to about 300,000 mg/L, about 90,000 to about 250,000 mg/L, about 90,000 to about 200,000 mg/L, about 90,000 to about 150,000 mg/L; from about 150,000 to about 300,000 mg/L, about 150,000 to about 250,000 mg/L, about 150,000 to about 200,000 mg/L; from about 230,000 to about 300,000 mg/L, about 230,000 to about 250,000 mg/L, including any ranges or subranges thereof.

In step 220, a concentrated brine stream is produced by contacting the inlet brine stream with an ion exchange resin configured to extract water from the inlet brine stream, the ion exchange resin comprising a plurality of pores adapted to receive water molecules. As discussed above, in certain embodiments the ion exchange resin may remove water from the inlet brine stream via osmosis. Suitable ion exchange resin(s) used for method 200 may include those discussed above with regard to system 100.

In step 230, the contact of the ion exchange resin(s) is ceased with the inlet brine stream and the concentrated brine stream. The contact of the ion exchange resin(s) with the inlet brine stream and the concentrated brine stream may be ceased by removing the ion exchange(s) from the filtration housing. In some embodiments, the ion exchange resin may have been contact with the inlet brine stream before the contact is ceased for at least 1 minute, at least 5 minutes, at least 30 minutes, at least 60 minutes, at least 120 minutes, at least 180 minutes, or at least 240 minutes. Additionally or alternatively, the ion exchange resin may remain in contact with inlet brine stream until the ion exchange resin(s) swell to have an average diameter and/or average size that is about 150% or more larger than size of the ion exchange resin when in a dry state. In some embodiments, the ion exchange resin may remain in contact with inlet brine stream until the ion exchange resins swell to an average diameter and/or average size that is larger than the ion exchange resin in a dry state by about 150 to about 400%, about 150 to about 300%, about 150 to about 200%; about 200 to about 500%, about 200 to about 400%, about 200 to about 300%; from about 250 to about 500%, about 250 to about 400%, about 250 to about 300%, about 250 to about 200%; from about 300 to about 500%, about 300 to about 400%; from about 350 to about 500%, about 350 to about 400%, or any range or subrange thereof.

In step 240, at least a portion of the water contained in the ion exchange resin(s) is evaporated using an evaporation unit (e.g., evaporation unit 120). The at least a portion of water in the ion exchange resin(s) may be evaporated by contacting the ion exchange resin(s) with an inlet gas stream (e.g. inlet gas stream 122) having a first relative humidity of less than 100%. Thus, in some embodiments, method 200 further comprises providing an inlet gas stream having a first relative humidity of less than 100%; contacting the ion exchange resin with the inlet gas stream to evaporate at least a portion of the water and produce an outlet gas stream having a second relative humidity, wherein the second relative humidity of the outlet gas stream is greater than the first relative humidity of the inlet gas stream.

The ion exchange resin(s) may be contact with the inlet gas stream and/or in the evaporation unit resins for at least 1 minute, at least 5 minutes, at least 30 minutes, at least 60 minutes, at least 120 minutes, at least 180 minutes, or at least 240 minutes. Additionally or alternatively, the ion exchange resins may be in contact with the inlet gas stream and/or in the evaporation unit until the average size of the ion exchange resin(s) shrinks by about 30% or more, about 40% or more, about 50% or more, about 60% or more, about 70% or more, about 75% or more, about 80% or more, about 85% or more, or about 90% or more.

In further embodiments, the ion exchange resin(s) may remain in contact with the inlet gas stream and/or in the evaporation unit until the ion exchange resin(s), on average, release about 50% or more, about 60% or more, about 70% or more, about 80% or more, about 85% or more, about 90% or more, about 95% or more, about 97% or more, or about 99% or more of the water contained in the ion exchange resins. The amount of water released by the ion exchange resin(s) may be determined by a change in weight of the ion exchange resin(s). Additionally or alternatively, the amount of water released by the ion exchange resin(s) may be determined by a change in relative humidity of the outlet gas stream (e.g., outlet gas stream 124) from the evaporation unit. For example, method 200 may include measuring the second relative humidity of the outlet air stream using a sensor; and removing the one or more ion exchange resin from the evaporation unit after the second relative humidity reaches a predetermined value. In some cases, the predetermined value is a decrease in the second relative humidity of about 10% or more, about 20% or more, about 30% or more, about 40% or more, or about 50% or more.

Method 200 may also include recovering water from the outlet gas stream by condensing at least a portion of the water contained in the outlet gas stream using a condenser, such as condenser 130.

### EXAMPLES

### Example 1

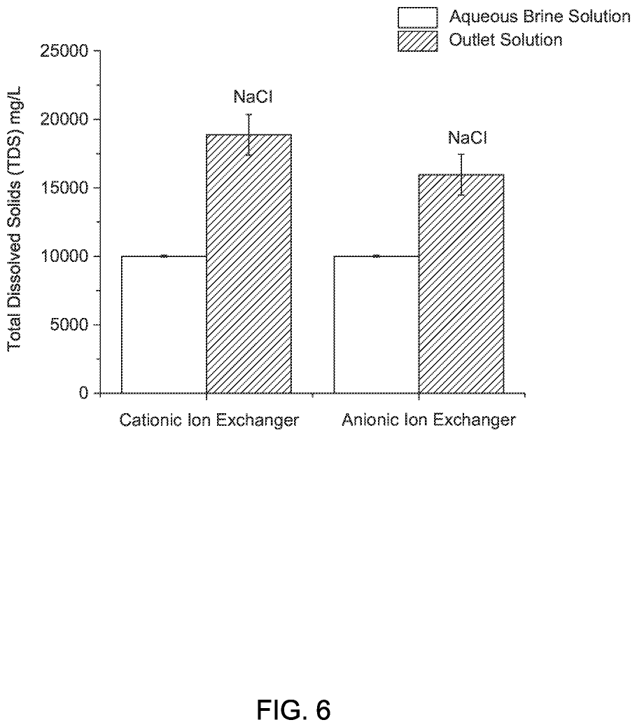

An aqueous brine solution containing sodium chloride and having 10,000 mg/L of total dissolved solids (hereafter “TDS”) was slowly passed through air-dried hybrid cation and anion exchange resins. The brine solution (i.e., NaCl in water) was prepared in the lab by dissolving NaCl in distilled water. Concentrations were measured only in TDS including that for NaCl which was the only solute present in the solution. Volume of solution passed corresponded to approximately two bed volumes of air-dried ion exchange resins. Swelling was observed for both cation and anion exchange resins and the samples of the outlet solution were collected at the exit of the short column were tested for TDS. FIG. 6 illustrates that the TDS in the outlet solution in both cases is significantly greater than the in the aqueous bring solution. This observation validates the novel proposition that the water uptake within the ion exchange resin phase is governed by osmosis where electrolytes are rejected, thus increasing the TDS in the external solution.

### Example 2

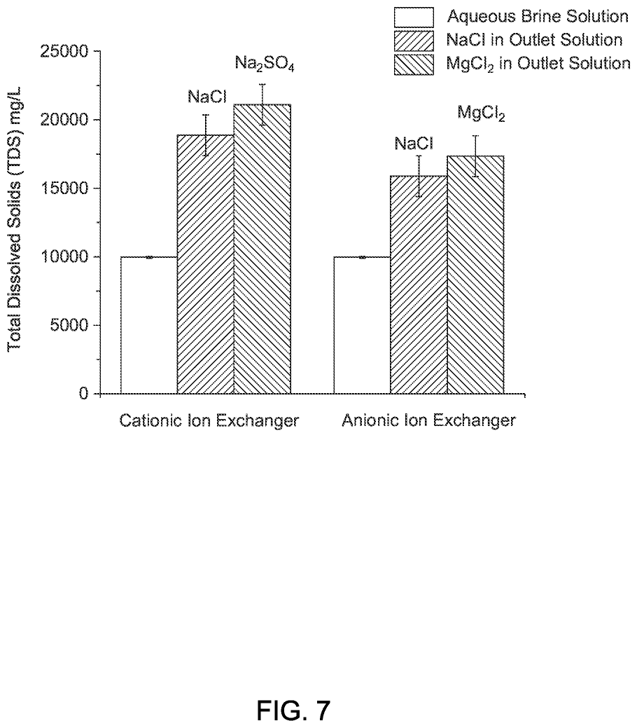

To assess the effects of the cationic or anionic functional groups of the ion exchange resins from Example 1, Na₂SO₄ solution was passed through the cation exchange resin while MgCl₂ was passed through the anion exchange resin. All other experimental conditions remaining identical. It was determined that divalent sulfate (SO₄²⁻) was rejected more than Cl⁻ by the cation exchange resin with fixed negative functional groups while the divalent cation (Mg²⁺) was rejected more than Na by the anion exchange resin with fixed positive functional groups. FIG. 7 illustrates that for Na₂SO₄, the outlet solution is more concentrated than when NaCl was passed through the air-dried cation ion exchange resin. Likewise, for the anion ion exchange resin, MgCl₂ is significantly more concentrated in the outlet solution.

### Example 3

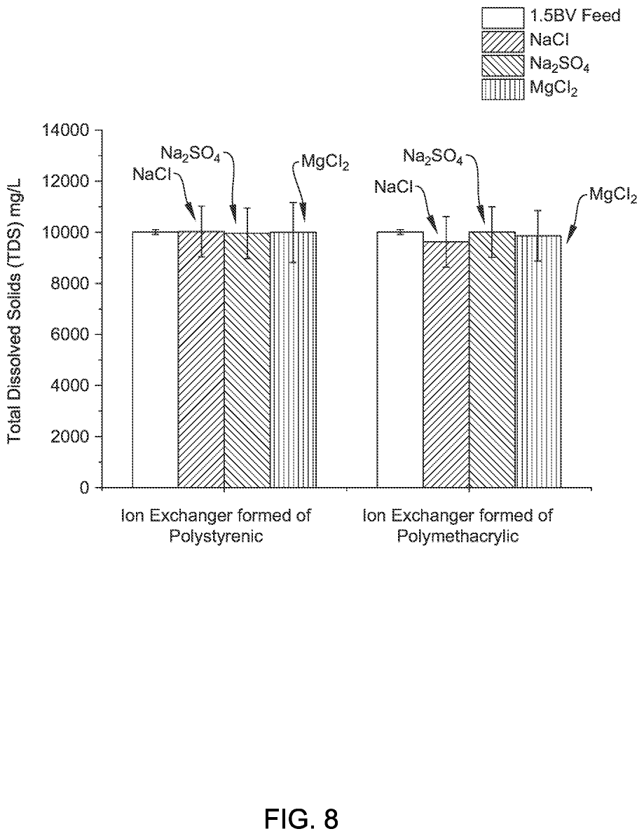

To further assess the effect of the cationic or anionic functional groups of the ion exchange resins, experiments similar to Examples 1 and 2 were carried out with either air-dried ion exchange resins formed of polymeric sorbents with polystyrene or air-dried ion exchange resins formed of polymeric sorbents with polyacrylic matrices, but containing no ion exchange functional groups. As seen in FIG. 8, there was no change in the concentration of TDS in the outlet solution in the absence of ion exchanging functional groups. The results indicated that non-ionized sorbents, polystyrenic (hydrophobic) and polymethacrylic (hydrophilic) matrices do not concentrate saline water in the absence of charged functional groups. Notably, the concentrations of the feed streams increased only when they were brought in contact with ion exchange resins (FIGS. 6 and 7) because such ion exchange resins preferentially took pure water inside while rejecting the salts or ions.

### Example 4

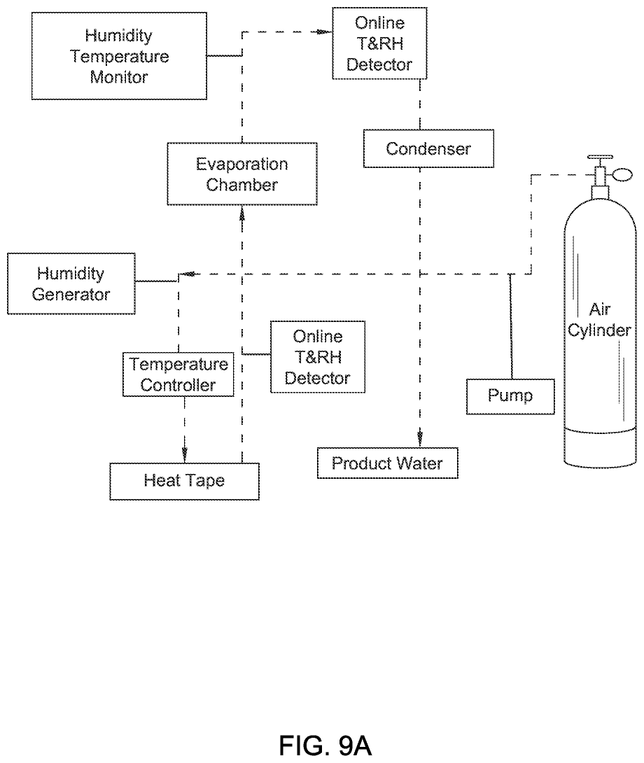

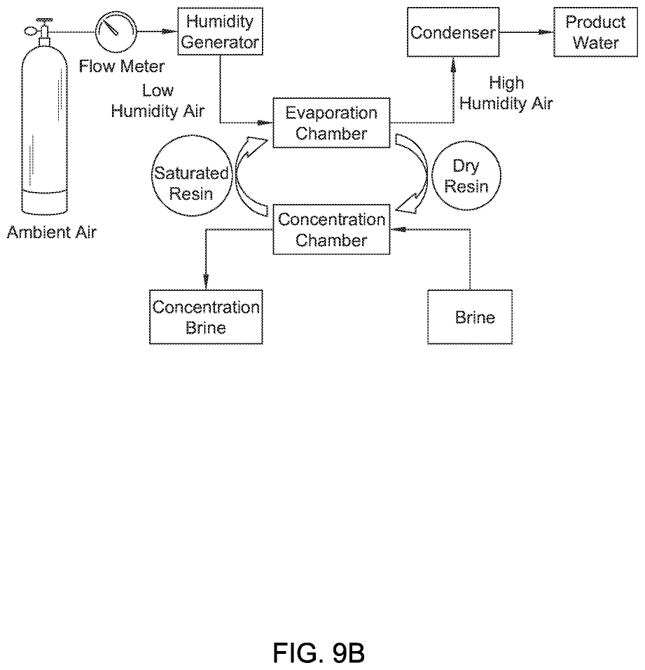

A method combining the removal of water from a feed solution using ion exchange resins and subsequent recovery of at least a portion of the water in the ion exchange resins using evaporation was evaluated. An illustration of the equipment for recovering water from the ion exchange resins is shown in FIG. 9A. A schematic of the system for removing water from a feed stream using ion exchange resins and subsequently recovering water from the ion exchange resins using evaporation is shown in FIG. 9B.

Specifically, 50 grams of dry hybrid ion exchange resins was used. After contacting the ion exchange resins with brine water, the dry hybrid ion exchange resins swelled through water uptake. Then the water-saturated ion exchange resins were packed in an evaporation chamber. Air from an air cylinder was passed through the evaporation chamber at 4.6 kg*dry air/hour with a pre-determined relative humidity aided by a humidity generator and heating tape. The humidity generator controlled the flowing air at constant temperature and relative humidity by mixing dry air and water vapor. There were two temperature and relative humidity duo-detector installed in the vaporization chamber (e.g., inlet port and outlet port). During the evaporation period, the detectors directly sensed and signaled the temperature and relative humidity data. The exiting air stream, which had a lower temperature (wet bulb temperature) and higher relative humidity, was then provided to a condenser to obtain water in the liquid phase.

### Example 5

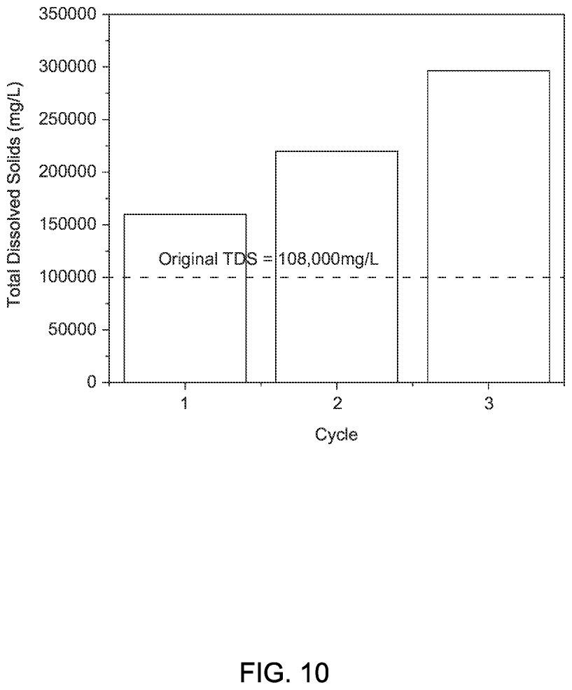

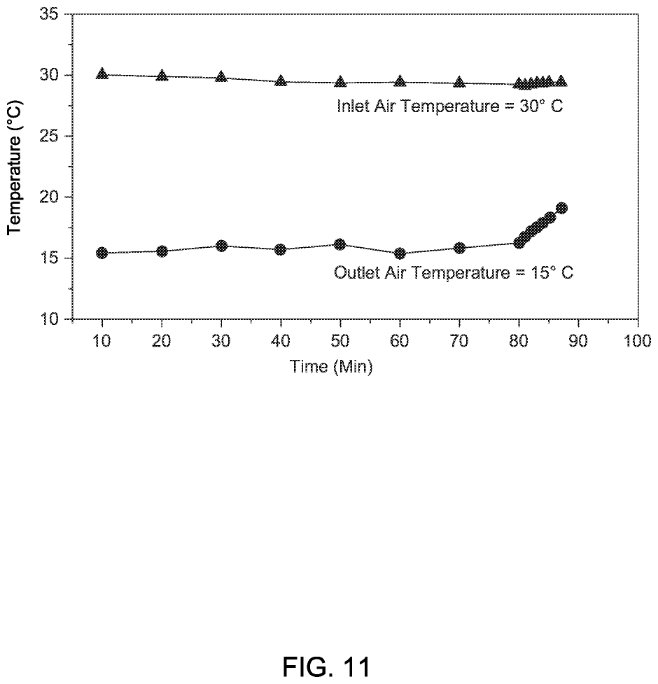

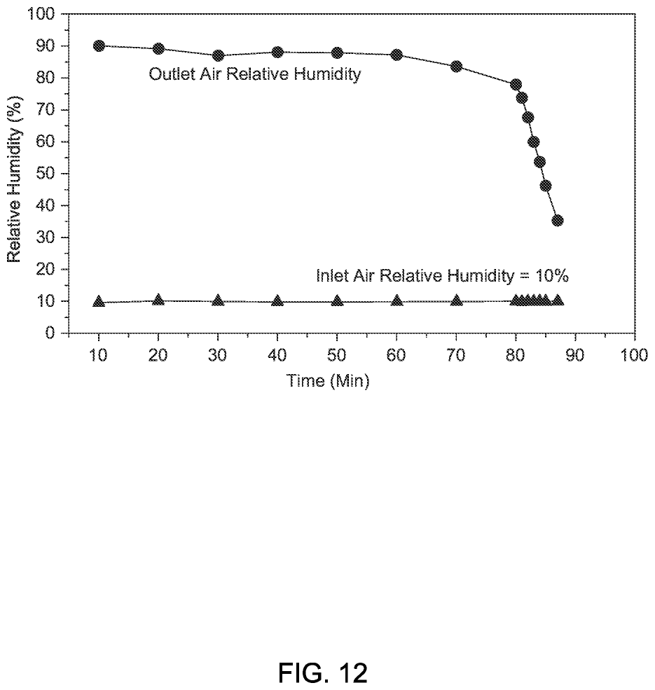

The efficacy of the system described in Example 4 was evaluated using feed solution representing a typical brine having concentration of TDS of 108,000 mg/L and ambient air at 30° C. with a relative humidity of 10% for recovering the water from the ion exchange resins. As seen in FIG. 10 the outlet solution had an increased concentration of TDS. The inlet and outlet temperatures of the air flowing through the evaporation unit while the relative humidity values are shown in FIGS. 11 and 12. Inlet air temperature of 30° C. with relative humidity of 10% is representative of many arid inland regions in southwest USA including Arizona, Nevada, and Texas. Note that the outlet temperature drops to less than 20° C. while the relative humidity increases to over 90% for every cycle, thus concentrating the feed stream. The end of the evaporation cycle can be determined by monitoring the relative humidity of the exiting air i.e., the evaporation cycle is essentially over as the relative humidity shows a steep downward drop.

An energy balance calculation was calculated to assess energy requirement, which is shown in Table 1 below. Based on the energy balance calculation, it was determined that the latent heat of brine vaporization is provided almost solely by the unsaturated air at low relative humidity.

TABLE 1
Energy Balance Calculation

| Q Energy release from Low Humidity Air | 71.67 KJ |
|---|---|
| L Water Latent Heat of Vaporization | 73.65 KJ |
| Difference | 3% |

*(One hour and constant air flow rate = 4.6 kg/hour)

In Table 1, Q is the energy release from the low humidity air and the L is the water latent heat of vaporization. The two calculated numbers are nearly the same, which indicated that our water evaporation energy is almost from unsaturated low humidity air. In many arid in-land regions, energy-efficient brine concentration is of much greater environmental and economic significance because of reduced disposal volume and space requirement. This is particularly so because deep well injection is increasingly under close scrutiny due to long-term adverse impacts.

### Example 6

The system described in Example 4 evaluated with a wastewater solution from Pennsylvania and New Jersey Marcellus gas well sites containing total dissolved solids (TDS) higher than 150,000 mg/L. Specifically, the waste water sample was collected from an active gas well in Williamsport, Pa. The concentrations of major dissolved constituents in the wastewater solution are shown in the following Table 2, below. The wastewater solution may contain high barium and calcium, which are likely to precipitate and cause fouling in the presence of sulfate.

TABLE 2
Marcellus Produced Hypersaline Wastewater Component

| Species and Condition | Concentration and Value |
|---|---|
| Na (mg/L) | 59000 |
| Ca (mg/L) | 18000 |
| Cl (mg/L) | 139000 |
| Ba (mg/L) | 23000 |
| Sr (mg/L) | 5000 |
| Conductivity (mS⁻¹) | 195.1 |
| pH | 5.2 |

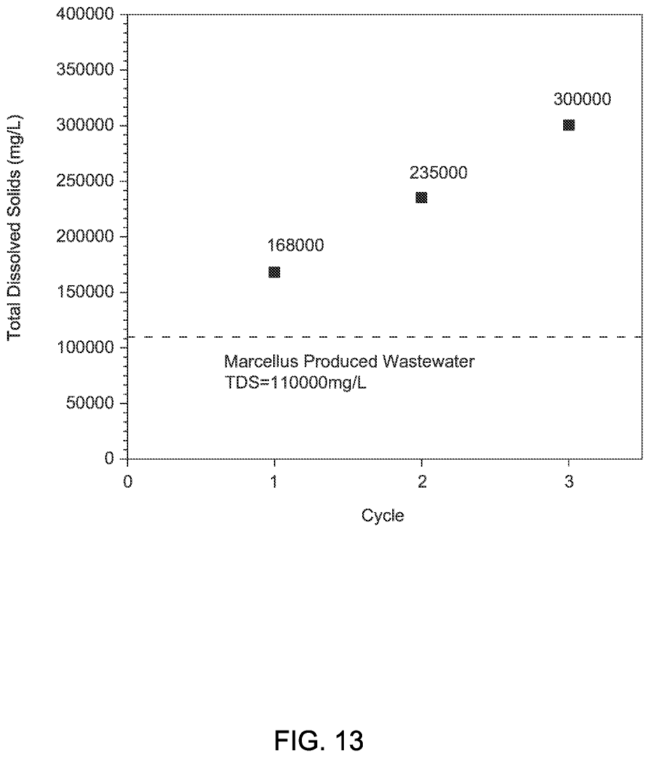

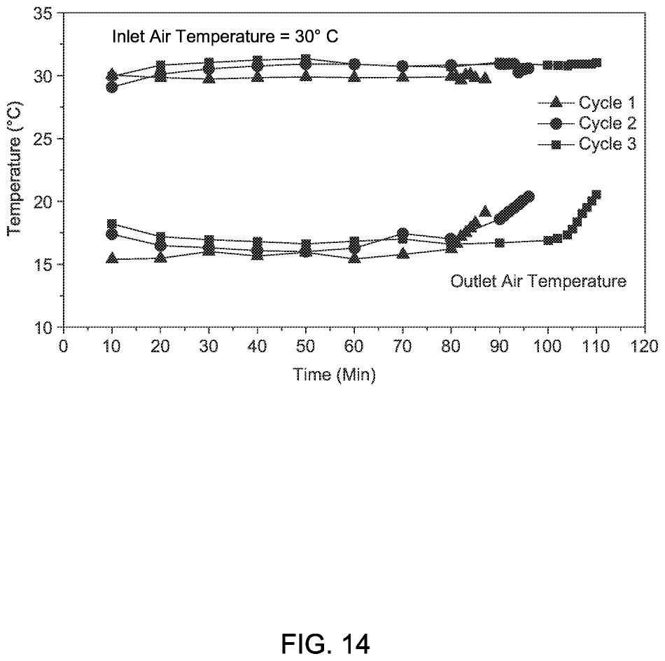

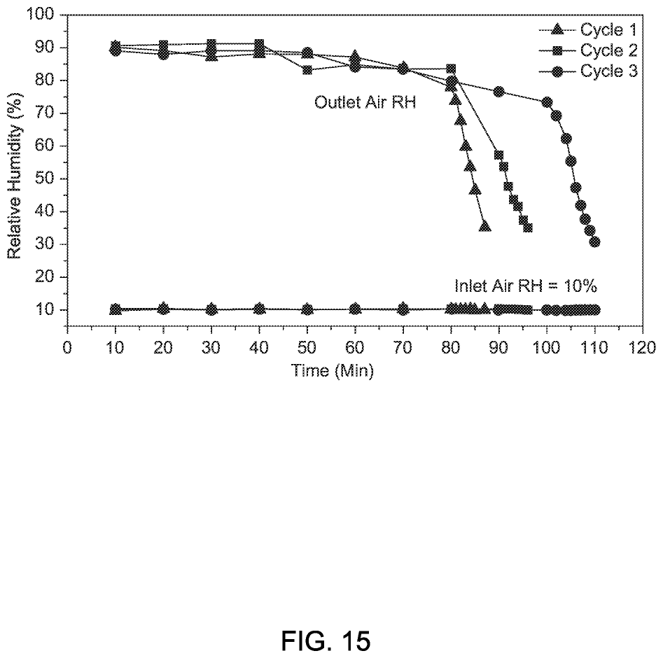

For Marcellus produced wastewater concentration, the method removing water from a feed stream using ion exchange resins and subsequently recovering water from the ion exchange resins using evaporation was evaluated for three cycles and the TDS increased from 110,000 mg/L to around 300,000 mg/L in three cycles, as shown in in FIG. 13. The inlet and outlet air temperatures curves of three consecutive evaporation cycles for real Marcellus produced wastewater were presented in FIG. 14, while FIG. 15 showed their humidity values. It is expected that relative humidity of the air increased from 10% in the inlet air to 90% in the exiting air.

### Example 7

The evaporation rate of water from the ion exchange resin was prophetically assessed in comparison to an evaporation lagoon. An evaporative lagoon is a commonly used technology where water vapor pressure is the driving force and it is relatively low at ambient temperature. For IXO-E process, on the contrary, relative humidity is the driver and temperature has a minor effect. Furthermore, for lagoons, mass transfer area per unit volume of brine solution is low and inversely proportional to the depth (D) of the lagoon. A typical evaporation lagoon for brine disposal normally has a depth ranging from one to two feet i.e., 30 to 60 cm. An equation for calculating the mass transfer area (α₁) for an evaporation lagoon is provided below.

$${a}_{1} = \frac{A}{V} = \frac{V / D}{V} = \frac{1}{D} = 0.0 \; 16 {cm}^{- 1}$$

Thus, mass transfer area per unit volume of brine for an evaporation lagoon is α₁=0.016 cm-1. For ion exchange resins having a bead shape, evaporation takes place through the surfaces of ion exchange resin beads. In this example, the ion exchange resin bead had an average diameter of 0.5 mm. The mass transfer area per unit volume (α₂) for an ion exchange resin bead can be calculated using the equation shown below:

$${a}_{2} = \frac{A}{V} = \frac{\frac{V}{\frac{4 π {r}^{3}}{3}} * 4 π {r}^{2}}{V} = \frac{3}{r} = 120 {cm}^{- 1}$$

A ratio of the mass transfer area per unit of the ion exchange resin bead to the mass transfer area per unit of the evaporation pool can be calculated using the following equation:

$$\frac{{a}_{2}}{{a}_{1}} = 7500$$

Thus, with all other conditions remaining the same, the rate of evaporation through ion exchange resin beads will be approximately 7500 times faster compared to typical evaporation lagoons.

### Example 8

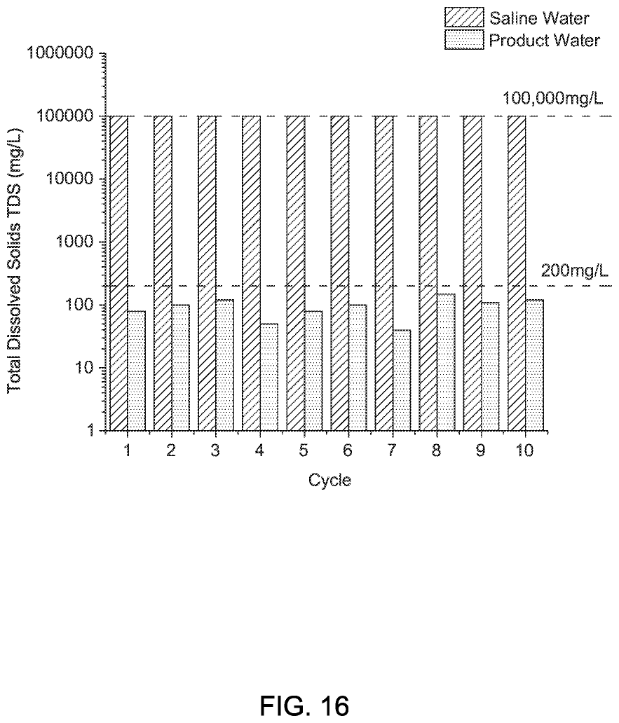

The system described in Example 4 was evaluated with a hyper brine feed solution. Specifically, by appropriately designing the evaporation and cooling steps, water with high salinity (100,000 mg/L) can be desalinated and the product water (less than 200 mg/L TDS) with high recovery can be obtained. As seen in FIG. 16, a recovery of 25% was obtained, and the TDS of the treated water was consistently less than 200 mg/L, over ten cycles of operation using feed concentration of 100,000 mg/L. The 25% recovery means that if the feed water volume is 100 liters with a salinity or TDS of 100,000 mg/L, then 25 liters will be the product water with a TDS of only 200 mg/L and 75 liters will be the reject water and the TDS there will be higher than 100,000 mg/L. Reverse Osmosis filtration membranes typically cannot desalinate a feed water with a TDS of 100,000 mg/L.

### Example 9

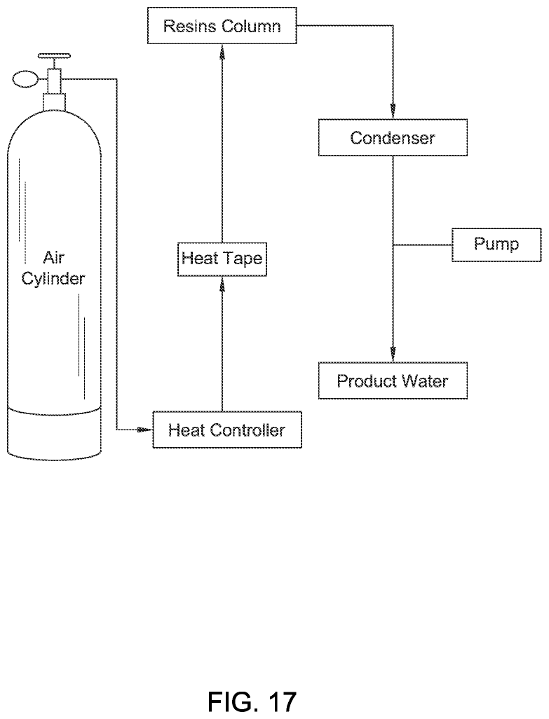

A non-limiting, exemplary system for removing water from a feed stream using ion exchange resins and subsequently recovering water from the ion exchange resins using evaporation was evaluated. FIG. 17 provides an image of the system evaluated in this Example. The ion exchange resin was a cationic ion exchange resin having a bead shape. The feed solution had a concentration of 100,000 mg/L of NaCl. After the ion exchange resins swelled with water from the feed solution, the ion exchange resins were dried to evaporate the water with hot air. The ion exchange resins were submerged in feed solution, removed, and dried four additional times to complete a total of five cycles of water recovery.

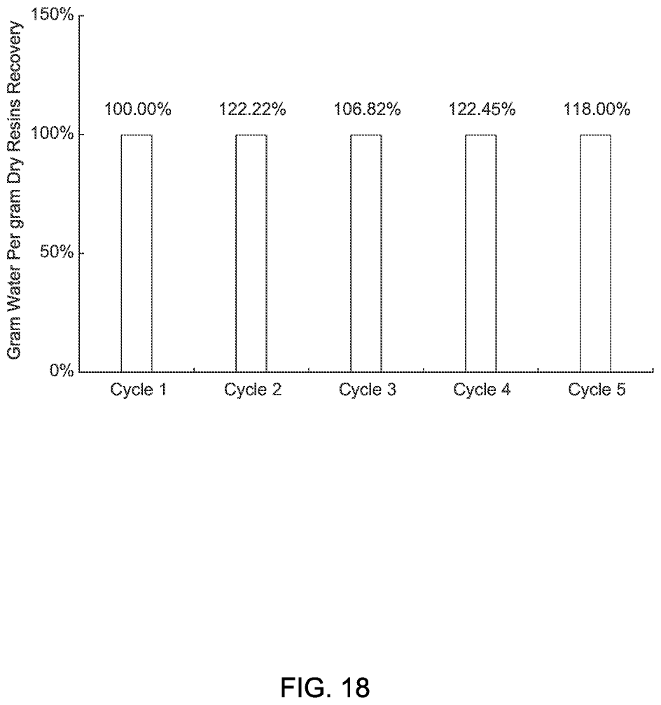

FIG. 18 shows the water recovered for each of the five cycles. Notably, the amount of water recovered from the ion exchange resins was greater than the dry weight of the ion exchange resins.

### Example 10

A non-limiting prophetic example of a system for recovering water assessed to evaluate energy requirements for recovering water from an aqueous solution. The system included a low-cost solar thermal energy units using thermal oil to provide more than 90% energy requirement of the proposed desalination process. The solar heat supply system is integrated with thermal energy storage which provide continuous supply of heat for desalination process.

It was determined that the energy needed for dehumidification of the ion exchange resin could be provided through low-cost solar thermal source and it constitutes more than 90% of the total energy requirement. The process can continue during both day and night with solar thermal energy storage. One kilogram of ion exchange resin (WAC-Na) may produce more than 0.5 kg of desalinated product water in one cycle requiring less than one hour. Also, WAC-Na can safely withstand a temperature of 80° C. without adverse effect and has a life expectancy of at least five year. Thus, one kg of WAC-Na can consistently produce over 10 kgs per day or 350 Kgs of desalinated product water pers month without external addition of any chemical for over 50% recovery. A cycle for removing water from a feed solution using the ion exchange resin and recovering the water from the ion exchange resin via evaporation and then condensation may be completed in about an hour. The source of cooling water can be reject water from an in-land lagoon or treated municipal wastewater or a combination of them including atmospheric air or a chiller depending on the location and/or economics.

1. A method for recovering water from a brine stream, the method comprising:
receiving an inlet brine stream comprising water and a solute;
producing a concentrated brine stream by contacting the inlet brine stream with an ion exchange resin configured to extract water from the inlet brine stream, the ion exchange resin comprising a plurality of pores adapted to receive water molecules;
ceasing the contact of the ion exchange resin with the inlet brine stream and the concentrated brine stream; and
evaporating at least a portion of the water contained in the ion exchange resin using an evaporation unit.

2. The method according to claim 1, wherein the ion exchange resin comprises an ion exchange resin is in the form of a bead.

3. The method according to claim 1, wherein evaporating the at least a portion of the water comprises:
providing an inlet gas stream having a first relative humidity of less than 100%; and
contacting the ion exchange resin with the inlet gas stream to evaporate at least a portion of the water and produce an outlet gas stream having a second relative humidity, wherein the second relative humidity of the outlet gas stream is greater than the first relative humidity of the inlet gas stream.

4. The method according to claim 3 further comprising:
recovering water from the outlet gas stream by condensing at least a portion of the water contained in the outlet gas stream using a condenser.

5. The method according to claim 3, wherein the inlet gas stream comprises air.

6. The method according to claim 3, wherein the first relative humidity is less than 100%.

7. (canceled)

8. The method according to claim 1, further comprising:
measuring the second relative humidity of the outlet air stream using a sensor;
removing the one or more ion exchange resin from the evaporation unit after the second relative humidity reaches a predetermined value, wherein the predetermined value is a decrease in the second relative humidity of about 10% or more.

9. (canceled)

10. (canceled)

11. The method according claim 1, wherein the ion exchange resin comprises a doping agent, wherein the doping agent is a metal oxide selected from iron oxide, zirconium oxide, copper oxide, and a combination of two or more thereof.

12. (canceled)

13. The method according to claim 1, wherein the ion exchange resin produces the concentrated brine stream by extracting water via osmosis from the inlet brine stream.

14. The method according to claim 1, wherein the ion exchange resin is adapted to have a maximum water capacity at a relative humidity of 80% that is about 50% or less of the maximum water content of the ion exchange resin at a relative humidity of 100%.

15. A system for recovering water from an aqueous stream, the system comprising:
a filtration housing comprising:
an feed solution inlet configured to receive a feed stream;
one or more ion exchange resin doped with at least one metal oxide, the one or more ion exchange resin comprising a surface layer, an inner layer, and a plurality of pores adapted to receive water molecules, wherein at least one of the plurality of pores extends from the surface layer to the inner layer; and
a concentrated solution outlet configured to receive a concentrated stream; and
an evaporation unit configured to blow air in contact with the one or more ion exchange resin.

16. The system according to claim 15, wherein the one or more ion exchange resin is configured to retain water under a first condition and configured to release water under a second condition.

17. (canceled)

18. (canceled)

19. (canceled)

20. The system according to claim 15, wherein the ion exchange resin is adapted to have a maximum water capacity at 100% humidity ranging from about 1 gram of water per gram of ion exchange resin to about 3 grams of water per gram of ion exchange resin.

21. The system according to claim 1, wherein the ion exchange resin is adapted to have a maximum water capacity at a relative humidity of 80% that is about 50% or less of the maximum water content of the ion exchange resin at a relative humidity of 100%.

22. The system according to claim 1, the ion exchange resin is adapted to have a maximum water capacity at a relative humidity of 20% that is about 30% or less than the maximum water content of the ion exchange resin at a relative humidity of 100%.

23. The system according to claim 1, wherein the one or more ion exchange resin has a shape that is substantially spherical and comprises a plurality of nanofibers.

24. (canceled)

25. The system according to claim 1, wherein the ion exchange resin comprises a polymer selected from polystyrene, polyacrylic acid, and mixtures of two or more thereof.

26. (canceled)

27. The system according to claim 15, wherein the surface of the ion exchange resin includes a plurality of functional groups selected from a carboxylic acid, a sulfonic acid, a quaternary ammonium, a primary amine, and a combination of two or more thereof.

28. The system according to claim 15, wherein the at least one metal oxide comprises iron oxide, zirconium oxide, copper oxide, and a combination of two or more thereof.

29. (canceled)

30. A method for recovering water from an aqueous stream, the method comprising:
receiving an inlet aqueous stream comprising water and having a solute concentration level of about 1,000 mg/L to about 300,000 mg/L;
producing a concentrated aqueous stream by contacting the inlet aqueous stream with an ion exchange resin configured to extract water from the inlet aqueous stream, the ion exchange resin comprising a plurality of pores adapted to receive water molecules;
ceasing the contact of the ion exchange resin with the inlet aqueous stream and the concentrated inlet aqueous stream; and
evaporating at least a portion of the water contained in the ion exchange resin using an evaporation unit.
